(19) United States
(12) Patent Application Publication
(10) Pub. No.: US 2010/0214966 A1
(43) Pub. Date: Aug. 26, 2010

(54) Method For Setting Power Levels For User Equipments

(76) Inventors: Rong Hu, Beijing (CN); Per Magnus Lundevall, Sollentuna (SE); Per Olof Magnus Magnusson, Linkoping (SE); Arne Simonsson, Gammelstad (SE)

Correspondence Address: ERICSSON INC., 6300 LEGACY DRIVE, M/S EVR 1-C-11, PLANO, TX, 75024, US

(21) Appl. No.: 12/066,918

(22) PCT Filed: Sep. 19, 2005
(86) PCT No.: PCT/SE05/01373

§ 371 Date: Mar. 25, 2010

(51) Int. Cl. G08C 17/00

(52) U.S. Cl. 370/311

(57) ABSTRACT

The present invention relates to a base station and a method in a mobile communication network comprising means for transmitting information to User Equipments (UEs), on a first channel and means for transmitting data packets to said UEs on a second channel. The timing of the first channel and second channel is overlapping, and the base station comprises means for setting individual power levels of the first channel for each scheduled UE. The base station according to the present invention comprises means for setting the power level of the second channel for a first scheduled UE based on the power level setting for the first channel for at least a subsequently scheduled second UE based on an early UE scheduling decision.

### FIELD OF THE INVENTION

The present invention relates to a mobile telecommunication network. In particular, it relates to optimization of the Node B power utilization during High Speed Downlink Packet Access (HSDPA) transmissions.

### BACKGROUND

The present invention relates to methods and arrangements in a Node B in a UMTS terrestrial radio access network (UTRAN). The UTRAN is illustrated in FIG. 1 and comprises at least one Radio Network System 100 connected to the Core Network (CN) 200. The CN is connectable to other networks such as the Internet, other mobile networks e.g. GSM systems and fixed telephony networks. The RNS 100 comprises at least one Radio Network Controller 110. Furthermore, the respective RNC 110 controls a plurality of Node-Bs 120,130 that are connected to the RNC by means of the lub interface 140. Each Node B, also referred to as base station, covers one or more cells and is arranged to serve the User Equipment (UE) 300 within said cell. Finally, the UE 300, also referred to as mobile terminal, is connected to one or more Node Bs over the Wideband Code Division Multiple Access (WCDMA) based radio interface 150.

Requirements for mobile data access are increasing and demand for bandwidth is growing. To meet these needs the HSDPA specification has been defined. HSDPA is based on WCDMA evolution standardized as part of 3GPP Release 5 WCDMA specifications. HSDPA is a packet-based data service in WCDMA downlink with data transmission peak rate up to 14.4 Mbps over a 5 MHz bandwidth. Thus HSDPA improves system capacity and increases user data rates in the downlink direction. The improved performance is based on adaptive modulation and coding, a fast scheduling function and fast retransmissions with soft combining and incremental redundancy. The adaptive modulation and coding makes it possible to adapt the modulation scheme and coding according to the quality of the radio link. The fast scheduling function of the transmission of data packets over the radio interface is performed in the base station based on information about the channel quality, terminal capability, QoS class and power/code availability. The scheduling is denoted fast because it is performed as close to the radio interface as possible and because a short frame length is used. Fast retransmission implies that the requests for retransmission are performed by the base station instead of the Radio Network Controller (RNC) as in traditional WCDMA systems. By implementing the retransmission function in the base station instead of the RNC it is possible to achieve a faster retransmission.

HSDPA utilizes a transport channel named the High Speed Downlink Shared Channel (HS-DSCH) that makes efficient use of valuable radio frequency resources and takes bursty packet data into account. This is a shared transport channel which means that resources, such as channelization codes, transmission power and infra structure hardware, is shared between several users. When one user has sent a data packet over the network, another user gets access to the resources and so fourth. In other words, several users can be time multiplexed so that during silent periods, the resources are available to other users. On the other hand, several users can share the resource simultaneously by code multiplexing. Furthermore, HSDPA utilizes a control channel named the High Speed Shared Control Channel (HS-SCCH) that serves the purpose of informing which UE that is to receive the HS-DSCH in the next time period. The HS-SCCH also tells the scheduled UE about transmission parameters of the HS-DSCH.

The HS-SCCH channel has fixed control information content and thereby, the required transmission power need to be adjusted according to the radio channel quality to be received by the UE. The HS-DSCH has variable payload information content for best effort data and the amount of data is adapted to the available power and radio channel quality.

The transmission time in a WCDMA system is divided into Transmission Time Intervals (TTIs). The TTI length for the HS-DSCH equals 2 ms, i.e. three slots as shown in FIG. 2. The timing for the High Speed Shared Control Channel (HS-SCCH) is two slots ahead of the HS-DSCH for a particular UE. That depends on that information such as transport format, UE identity and channelization code set is sent on the HS-SCCH in order to prepare the UE for receiving data on the HS-DSCH.

Due to the staggered timing of the High Speed Downlink Shared Channel (HS-DSCH) and the High Speed Shared Control Channel (HS-SCCH) transmissions as shown in FIG. 2, the base station usually adopts a relatively conservative solution when the available power for the HS-DSCH is estimated by assuming that the HS-SCCH transmission for the next TTI will be the maximum allowed HS-SCCH power. Thus, resources may be wasted (denoted wasted resource) if the maximal allowed HS-SCCH is not required to be used shown in FIG. 2. It should be noted that this application relates to the case when the HS-SCCH power is set individual for each UE.

An alternative solution is to use the actual left power for the HS-DSCH, and not to assume that the maximal HS-SCCH power is used. However in this solution, there is a risk that the total power level exceeds the available total power level due to the staggered timing of HS-DSCH and HS-SCCH. I.e. the selected power of the HS-DSCH for a first scheduled UE together with the HS-SCCH power of a subsequently scheduled second UE may exceed the available HS power. This overbooking is illustrated in FIG. 3. Due to the risk of overbooking the downlink, power limiting functions in the base station will usually reduce power for all channels (including common control channels and traffic channels) and eventually degrade the quality of all on going connections in the cell.

The problem with the trade-off between overbooking risk vs. under utilization of power will increase in the case of code multiplexing. I.e. a multiple of users are code-multiplexed onto the same TTI. In that case there is one HS-SCCH for each multiplexed user. Thus, it will be a large waste of power to reserve the maximal HS-SCCH power times the maximal number of multiplexed users. The potential resource waste is illustrated in FIG. 4.

Thus, an object of the present invention is to provide a method and arrangements that utilize the power of the base station more efficiently than existing solutions when channels with staggered timing are used, which results in higher system performance in terms of higher throughput, higher user bit rate, decreased delay and enhanced system capacity.

### SUMMARY OF THE INVENTION

The object of the present invention is achieved by the method according to claim 1, and the arrangements of claims 12-14.

Preferred embodiments are defined by the dependent claims.

The method in a base station of a mobile telecommunication network according to the present invention makes it possible to utilize the power of the base station more efficiently than existing solutions when channels with staggered timing are used, which results in higher system performance in terms of higher throughput, higher user bit rate, decreased delay and enhanced system capacity. Said base station comprises means for transmitting information to User Equipments (UEs) on a first channel and for transmitting data packets to said UEs on a second channel and wherein the timing of the first channel and second channel is overlapping, according to the present invention. The method comprises the step of setting individual power levels of the first channel for each scheduled UE, and setting the power level of the second channel for a first scheduled UE based on the power level setting for the first channel for at least a subsequently scheduled second UE based on an early UE scheduling decision.

The computer program according to the present invention product directly loadable into the internal memory of a computer within a base station, comprising the software code portions for performing the steps of said method makes it possible to utilize the power of the base station more efficiently than existing solutions when channels with staggered timing are used, which results in higher system performance in terms of higher throughput, higher user bit rate, decreased delay and enhanced system capacity.

The computer program product according to the present invention stored on a computer usable medium, comprising readable program for causing a computer, within a base station, to control an execution of the steps of said method makes it possible to utilize the power of the base station more efficiently than existing solutions when channels with staggered timing are used, which results in higher system performance in terms of higher throughput, higher user bit rate, decreased delay and enhanced system capacity.

The base station of a mobile telecommunication network according to the present invention, makes it possible to utilize the power of the base station more efficiently than existing solutions when channels with staggered timing are used, which results in higher system performance in terms of higher throughput, higher user bit rate, decreased delay and enhanced system capacity. Said base station comprises means for transmitting information to User Equipments on a first channel and means for transmitting data packets to said UEs on a second channel and wherein the timing of the first channel and second channel is overlapping. Further, the base station comprises means for setting individual power levels of the first channel for each scheduled UE and means for setting the power level of the second channel for a first scheduled UE based on the power level setting for the first channel for at least a subsequently scheduled second UE based on an early UE scheduling decision.

According to one embodiment of the present invention, the power level setting of the second channel for a first scheduled UE is based on the power level setting for the first channel for a subsequently scheduled second UE for at least a next transmission time interval.

According to a further embodiment of the present invention, the power level setting of the second channel for a first scheduled UE is based on the power level setting for the first channel for a subsequently scheduled second UE for the next two transmission time intervals.

According to a further embodiment of the present invention, the early scheduling decision is treated as a tentative decision for the purpose of the setting of the power level of the second channel for a first scheduled UE based on the power level setting for the first channel for a subsequently scheduled second UE.

According to a further embodiment, the tentative decision is overruled if a new scheduled packet results in a large overbooking, and a new packet is scheduled if the amount of power overbooking is low resulting in minor performance degradation.

According to a further embodiment, a parameter in dB is used to determine whether the amount of overbooking is large or low.

According to a further embodiment, the UEs are scheduled in such a way that UEs with similar first channel power needs are scheduled in sequence.

According to a further embodiment, the first channel has a fixed radio quality requirement.

According to a further embodiment, the first channel has a fixed information content.

According to a further embodiment, the amount of data in the second channel is variable.

According to a further embodiment, the base station is adapted for High Speed Downlink Packet Access, HSDPA and that the first channel is a High Speed Shared Control Channel, HS-SCCH, and that the second channel is a High Speed Downlink Shared Channel, HS-DSCH.

According to a further embodiment, the power level of the first channel is based on an indication of the channel quality.

According to a further embodiment, the channel quality is indicated by the parameter Channel Quality Indicator (CQI).

According to a further embodiment, multiple UEs are code multiplexed onto the same transmission time interval.

According to a further embodiment, the UEs scheduled in sequence with similar first channel power needs are scheduled such that the scheduled sequence minimize the sum of all multiplexed first channel power needs.

An advantage of the present invention is that it improves the system performance greatly when code multiplexing is employed. In particular, the performance of code multiplexing is improved in the case when the number of code multiplexed users varies from TTI to TTI. In this case, the number of HS-SCCHs also vary and state of the art solutions become very inefficient.

A further advantage is that it makes it possible to avoid or decrease the overload risk in the alternative solution wherein the remaining power from the HS-SCCH is used for the HS-DSCH as described above.

### BRIEF DESCRIPTION OF THE DRAWINGS

FIG. 1 illustrates schematically a WCDMA network wherein the present invention may be implemented.

FIG. 2 illustrates graphically when the maximal SCCH power is used when the HS-DSCH power is estimated.

FIG. 3 illustrates graphically when the actual SCCH power is used when the HS-DSCH power is estimated.

FIG. 4 illustrates graphically the potential power waste in the case of code multiplexing.

FIG. 5 illustrates graphically the proposed solution according to the present invention of improving the power utilization.

FIGS. 6a and 6b illustrates graphically the gain achieved with HS-SCCH variation based scheduling according to an embodiment of the present invention.

FIG. 7 illustrates UEs scheduled for transmission.

FIG. 8 illustrates graphically reordering of users scheduled for transmission in order to gain resources according to a further embodiment of the present invention.

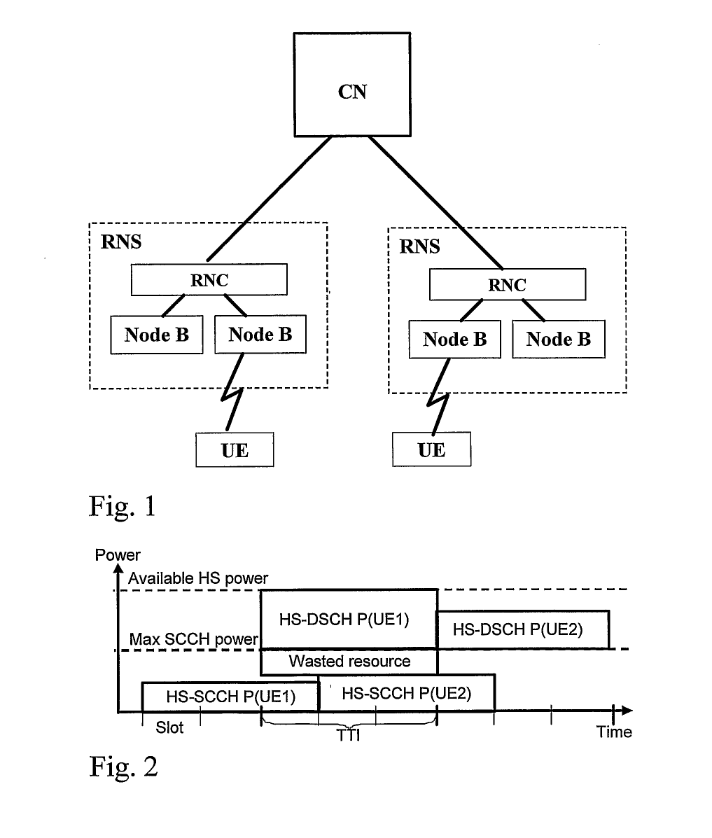

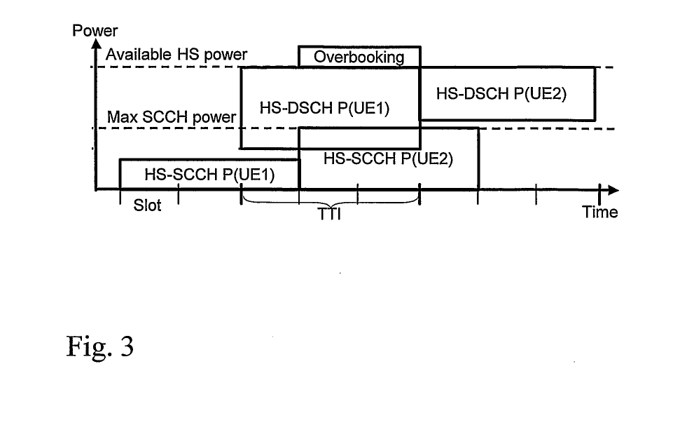

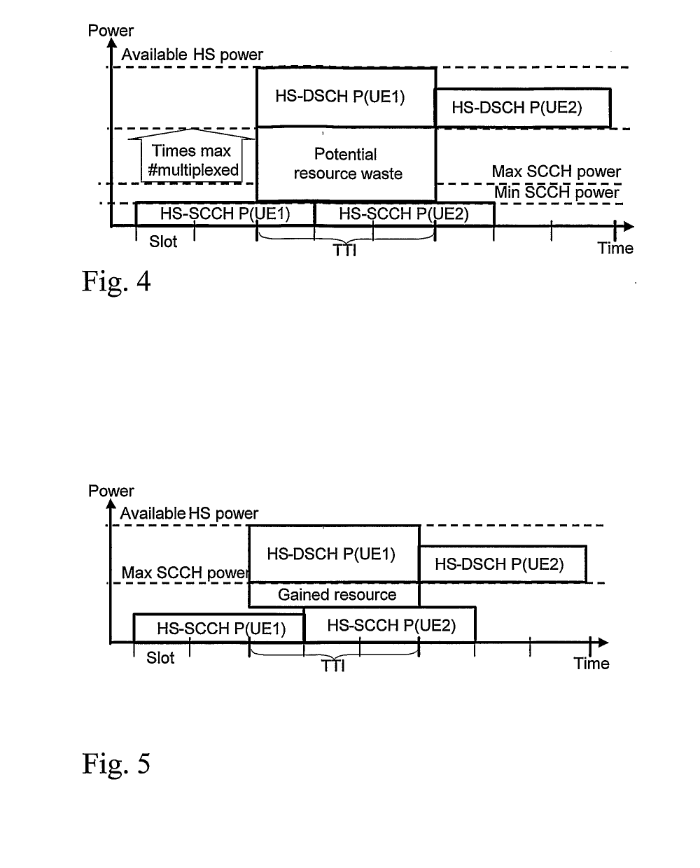

### DETAILED DESCRIPTION OF THE INVENTION

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention relates to a method and arrangements in a base station of a mobile telecommunication network. The base station comprises means for communicating with User Equipments (UEs) on a first channel and on a second channel and wherein the timing of the first channel and second channel is overlapping. The method comprises the steps of setting individual power levels of the first channel for each scheduled UE and setting the power level of the second channel for a first scheduled UE based on the power level setting for the first channel for at least a subsequently scheduled second UE based on an early UE scheduling decision for at least the second UE.

The present invention is preferably, but not necessary, implemented in a base station adapted for HSDPA, wherein the first channel is a HS-SCCH and the second channel is a HS-DSCH. It should be noted that the present invention is also applicable to other channels having a staggered timing and a power level setting that depends on each other and consecutive time frames/slots.

Thus in the case of HSDPA, the object of the present invention is achieved by utilizing that the HS-SCCH sub-frame is transmitted 2 slots prior to the start of the HS-DSCH sub-frame for a particular UE. The basic idea is to do a scheduling decision on the power level for the HS-DSCH for a first UE, based on the power level of the HS-SCCH for early subsequently scheduled UEs. The scheduling decision for the HS-DSCH is based on the power level for the HS-SCCH of at least the next TTI, but preferably of the next two TTIs. The proposed power utilization solution is illustrated in FIG. 5. The power level of the HS-SCCH may be determined by using an indication of the channel quality, e.g. by using the existing parameter Channel Quality Indicator (CQI).

The power level setting of the HS-DSCH according to the present invention is described by the following example. Suppose TTI 1 is used for UE1 and TTI 2 is used for UE2, P1 is the estimated HS-SCCH power for TTI 1, P2 is the estimated HS-SCCH power for the TTI 2, then the estimated HS-DSCH power for UE1 is

P(UE1HS-DSCH)=P(tot)−P(Non-HS)−max(P1,P2), i.e.,

if P2<=P1, P(UE1HS-DSCH)=P(tot)−P(Non-HS)−P1;

if P2>P1, P(UE1HS-DSCH)=P(tot)−P(Non-HS)−P2;

If no UE (or UE1 again) is scheduled for the next TTI (i.e., P2 does not exist),

P(UE1HS-DSCH)=P(tot)−P(Non-HS)−P1;

P(Non-HS) is the available power used for dedicated channels and common control channels, wherein the power of the common control channels are fix while the power of the dedicated channels varies.

P(tot) is the total power, i.e. P(tot)=P(Non-HS)+power of the HS-DSCH+power of the HS-SCCH.

In this way, efficient power utilization can be obtained while keeping the overload risks at a minimum. Thus, resources will be gained compared to the prior art solution as illustrated in FIG. 5.

According to one embodiment of the present invention, the early scheduling decision of which UE to be scheduled is treated as a tentative decision for the purpose of the power-setting algorithm according to the invention due to the fact that the scheduling decisions must be made one TTI earlier and thus be based on somewhat older information such as CQI report, transmitter buffer status, etc. In the next TTI, the final scheduling decision is made. If the same user is selected, an optimal power utilization is reached. In this way, the lowest possible scheduling decision delay is maintained, while efficient power utilization can be achieved most part of the time.

The decision whether to override the tentative scheduling or not is in this embodiment based on the amount of overbooking. If a new scheduled packet results in a large overbooking with the risk of major degradation of all transmissions the original tentative packet can be sent by delaying the new packet one TTI. If the amount of power overbooking is low resulting in minor performance degradation the new packet is scheduled. This is according to a further embodiment of the present invention controlled by a parameter, for example a threshold in dB.

According to a further embodiment of the present invention, the scheduling of UEs are adjusted in such a way that UEs with similar first channel, e.g. HS-SCCH power needs are scheduled in sequence in order to minimize the variations in first channel, e.g. HS-SCCH power.

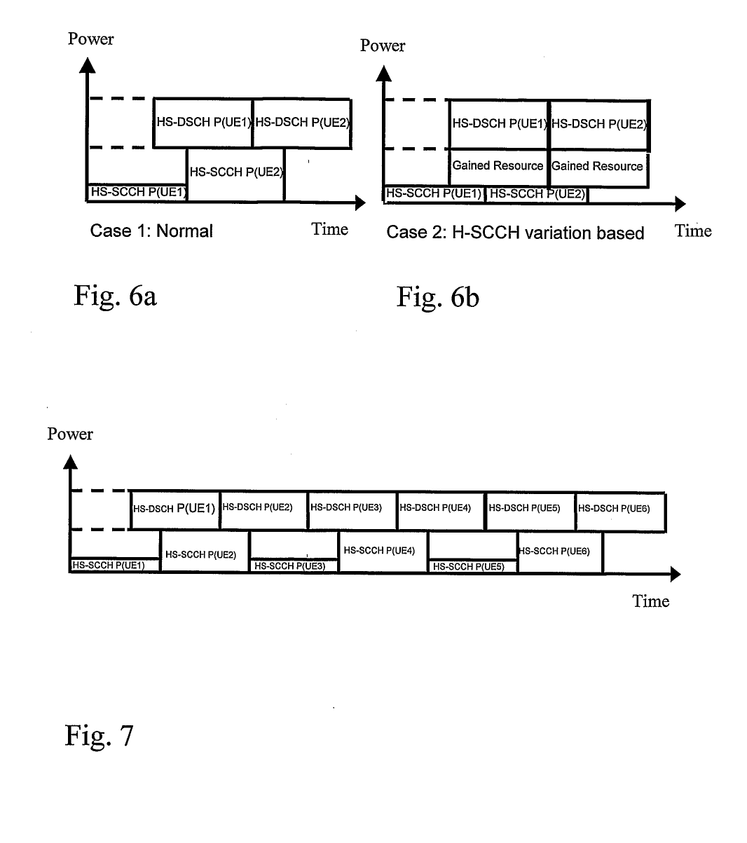

By keeping the HS-SCCH power variations small between subsequent users a larger portion of the remaining power for other reasons such as HS-DSCH is enabled to be used. The resources to be gained by scheduling the UEs in such a way that UEs with similar first channel (e.g. HS-SCCH) power needs are scheduled in sequence is shown in FIG. 6b compared with the conventional scheduling is shown in FIG. 6a.

One drawback with this solution according to the further embodiment in the case of HSDPA is that the scheduling mechanism is required to be affected in a way that the scheduling algorithm considers the required HS-SCCH power for each user. However, in practice, this drawback is often negligible. The reason is that most scheduling algorithms relies on CQI measurements as input and these are typically only received every n:th TTI in order to keep control signalling overhead on a reasonable level. This means that there is a pool of UEs that can be reordered without affecting the main goal of the scheduling algorithm. If the reordering is performed so that HS-SCCH power variations are minimized between subsequent UEs it is possible to take advantage of the gained resource without affecting the main goal of the radio-channel dependent scheduling algorithm.

This further embodiment is illustrated by the following example. Assume that there is a pool of 6 UEs, UE 1, 2, 3, 4, 5 and 6, that have been scheduled for transmission by the scheduling algorithm according to FIG. 7.

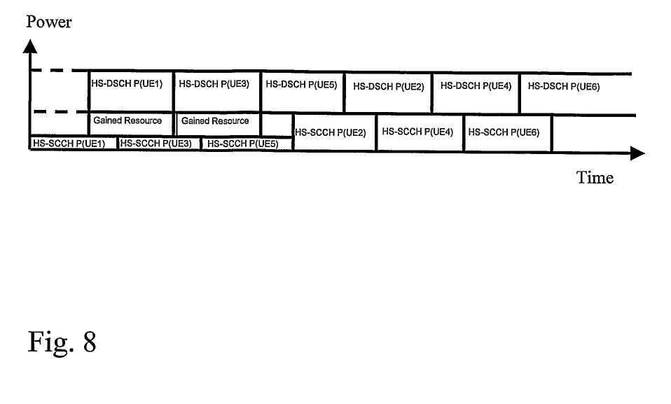

By reordering the users in the order 1, 3, 5, 2, 4 and 6 according to FIG. 8, the HS-SCCH power variations are minimized and it is hence possible to release downlink power resources (denoted gained resource) that can be used for other purposes such as increasing the data rate for HS-DSCH transmissions. In the case of code multiplexing, the gain potential for HS-SCCH variation based scheduling is even higher due to that the HS-SCCH power consumes a larger amount of the total downlink power resource and that it is enough to minimize the variations for the sum of the HS-SCCH power for all scheduled UEs per TTI. With code multiplexing there is an additional parameter to utilize, the number of multiplexed users per TTI. Since the total power for the HS-SCCH power then is the sum of all multiplexed users HS-SCCH power this gives a finer granularity to control the power. It applies to the reordering where the it is enough to reorder to minimize the sum of HS-SCCH power variation. It also applies to the delayed packets in case of large overbooking where not all packets have to be delayed but only the amount to lower the power below the threshold.

Thus, the method according to the present invention comprises the step:

Set the power level of the second channel, e.g. the HS-DSCH, for a first scheduled UE based on the power level setting for the first channel, e.g. the HS-SCCH, for at least a subsequently scheduled second UE based on an early UE scheduling decision for at least the second UE.

The method is according to one aspect implemented in a base station. Thus, the base station according to the present invention comprises means for setting the power level of the second channel, e.g. the HS-DSCH, for a first scheduled UE based on the power level setting for the first channel, e.g. the HS-SCCH, for at least a subsequently scheduled second UE based on an early UE scheduling decision for at least the second UE.

Furthermore, a computer program product may preferably implement the method of the present invention. Thus the present invention relates to a computer program product directly loadable into a processing means in a base station, comprising the software code means for performing the steps of said method. The present invention also relates to a computer program product stored on a computer usable medium, comprising readable program for causing a processing means in a base station, to control the execution of the steps of said method.

The present invention is not limited to the above-described preferred embodiments. Various alternatives, modifications and equivalents may be used. Therefore, the above embodiments should not be taken as limiting the scope of the invention, which is defined by the appending claims.

1. A method in a base station of a mobile telecommunication network, wherein the base station comprises means for transmitting information to User Equipments, UEs, on a first channel and means for transmitting data packets to said UEs on a second channel, wherein the transmission timing of the first channel and second channel to a first UE is overlapping, the method comprising the steps of:
setting individual power levels of the first channel for each scheduled UE; and,
setting the power level of the second channel for a first scheduled UE based on the power level setting for the first channel for at least a subsequently scheduled second UE based on an early UE scheduling decision.

2. The method of claim 1, wherein the step of setting the power level of the second channel for a first scheduled UE is based on the power level setting for the first channel for a subsequently scheduled second UE for at least a next transmission time interval.

3. The method of claim 2, wherein the step of setting the power level of the second channel for a first scheduled UE is based on the power level setting for the first channel for a subsequently scheduled second UE for the next two transmission time intervals.

4. The method of claim 1, further comprising the step of:
treating the early scheduling decision as a tentative decision for the purpose of the setting of the power level of the second channel for the first scheduled UE based on at least the power level setting for the first channel for the subsequently scheduled second UE.

5. The method of claim 4, further comprising the steps of:
overriding the tentative decision if a new scheduled packet results in a large overbooking, or
scheduling a new packet if the amount of power overbooking is low resulting in minor performance degradation.

6. The method of claim 5, wherein a parameter in dB is used to determine whether the amount of overbooking is large or low.

7. The method of claim 1, further comprising the step of:
scheduling the UEs in such a way that UEs with similar first channel power needs are scheduled in sequence.

8. The method according to claim 1, wherein the first channel has a fixed radio quality requirement.

9. The method according to claim 1, wherein the first channel has a fixed information content.

10. The method according to claim 1, wherein the amount of data in the second channel is variable.

11. The method according to claim 1, wherein the base station is adapted for High Speed Downlink Packet Access, HSDPA, and wherein the first channel is a High Speed Shared Control Channel, HS-SCCH, and the second channel is a High Speed Downlink Shared Channel, HS-DSCH.

12. The method according to claim 11, wherein the power level of the HS-SCCH is based on an indication of the channel quality.

13. The method according to claim 12, wherein the channel quality is indicated by a parameter Channel Quality Indicator (CQI).

14. The method according to claim 1, wherein multiple UEs are code multiplexed onto the same transmission time interval.

15. The method according to claim 14, wherein the UEs with similar first channel power needs scheduled in sequence are scheduled such that the scheduled sequence minimizes the sum of all multiplexed first channel power needs.

16-17. (canceled)

18. A base station of a mobile telecommunication network, comprising means for transmitting information to User Equipments, UEs, on a first channel and means for transmitting data packets to said UEs on a second channel, wherein the transmission timing of the first channel and second channel to a first UE is overlapping, the base station comprising:
means for setting individual power levels of the first channel for each scheduled UE; and,
means for setting the power level of the second channel for a first scheduled UE based on the power level setting for the first channel for at least a subsequently scheduled second UE based on an early UE scheduling decision.

19. The base station according to claim 18, wherein the means for setting the power level of the second channel for a first scheduled UE is adapted to base said power level setting of the second channel on the power level setting for the first channel for a subsequently scheduled second UE for at least a next transmission time interval.

20. The base station according to claim 19, wherein the means for setting the power level of the second channel for a first scheduled UE is adapted to base said power level setting of the second channel on the power level setting for the first channel for a subsequently scheduled second UE for the next two transmission time intervals.

21. The base station according to claim 18, further comprising means for treating the early scheduling decision as a tentative decision for the purpose of the setting of the power level of the second channel for a first scheduled UE based on at least the power level setting for the first channel for a subsequently scheduled second UE.

22. The base station according to claim 21, further comprising means for overriding the tentative decision if a new scheduled packet results in a large overbooking, and means for scheduling a new packet if the amount of power overbooking is low resulting in minor performance degradation.

23. The base station according to claim 22, wherein a parameter in dB is used to determine whether the amount of overbooking is large or low.

24. The base station according to claim 18, further comprising means for scheduling the UEs in such a way that UEs with similar first channel power needs are scheduled in sequence.

25. The base station according to claim 18, wherein the first channel has a fixed radio quality requirement.

26. The base station according to claim 18, wherein the first channel has a fixed information content.

27. The base station according to claim 18, wherein the amount of data in the second channel is variable.

28. The base station according to claim 18, wherein the base station is adapted for High Speed Downlink Packet Access, HSDPA, and wherein the first channel is a High Speed Shared Control Channel, HS-SCCH, and the second channel is a High Speed Downlink Shared Channel, HS-DSCH.

29. The base station according to claim 28, wherein the power level of the first channel is based on an indication of the channel quality.

30. The base station according to claim 29, wherein the channel quality is indicated by a parameter Channel Quality Indicator (CQI).

31. The base station according to claim 18, wherein multiple UEs are code multiplexed onto the same transmission time interval.

32. (canceled)
